(19) United States
(12) Patent Application Publication
(10) Pub. No.: US 2025/0234125 A1
(43) Pub. Date: Jul. 17, 2025

(54) OPEN BACK HEADPHONE WITH TACTILE VIBRATION DRIVER AND RELATED METHODS

(71) Applicant: Skullcandy, Inc., Park City, UT (US)

(72) Inventors: Randall J. Hull, Park City, UT (US); Matthew Western, Park City, UT (US); Michael Deans, Park City, UT (US)

(21) Appl. No.: 18/414,417

(22) Filed: Jan. 16, 2024

(51) Int. Cl. H04R 1/28; H04R 1/10

(52) U.S. Cl. CPC H04R 1/2888; H04R 1/1008; H04R 2400/03

(57) ABSTRACT

An open back headphone comprises a headband, a first earcup located at a first end of the headband, and a second earcup located at a second end of the headband. Each of the first earcup and the second earcup comprise a front plate, an acoustic driver mounted to the earcup, and a tactile vibration driver mounted to the earcup. Each of the first earcup and the second earcup may be configured to be disposed over or on an ear of a user during use of the headphone. Each of the first earcup and the second earcup do not include a rear acoustic cavity adjacent the back side of the acoustic driver. Each of the first earcup and the second earcup may be configured to allow ambient noise outside the earcup to pass through the earcup to the ear of the user without substantial passive isolation of ambient sound or sound generated by the acoustic driver during use of the headphone.

### FIELD

The present disclosure generally relates to open back headphones including multiple vibration members, which may include, for example, multiple acoustic drivers or at least one acoustic driver and at least one tactile vibration driver, and related methods. More specifically, disclosed embodiments relate to open back headphones including earcups having at least one acoustic driver, at least one tactile vibration driver and an at least partially open back configured to facilitate the release of excess energy created by the at least one acoustic driver and at least one tactile vibration driver to produce an improved sound response.

### BACKGROUND

Headphones including open back earcups are primarily employed to reduce the buildup of unwanted effects on sound quality. For example, closed back headphone systems typically have fully enclosed earcups which may be configured to reduce the impact of the environmental noise on the intended listening experience. The closed back of the earcups, however, may create resonance or low-frequency buildup, which may negatively impact the sound quality. Open back headphones allow air to pass through the earcup on the back side of the acoustic driver, such that there is not an enclosed acoustic cavity including the headphone audio driver adjacent the ear of the user.

### BRIEF SUMMARY

In some embodiments, an open back headphone comprises an earcup configured to be disposed over or on an ear of a user during use of the headphone. The earcup may include a front plate, an acoustic driver mounted to the earcup, and a tactile vibration driver mounted to the earcup. The acoustic driver may have a front side and a back side, and the tactile vibration driver may have a front side and a back side. The earcup does not include a rear acoustic cavity adjacent the back side of the acoustic driver, and the earcup is configured to allow ambient noise outside the earcup to pass through the earcup to the ear of the user without substantial passive isolation of ambient sound or sound generated by the acoustic driver during use of the headphone.

An open back headphone may comprise a headband, a first earcup located at a first end of the headband, and a second earcup located at a second end of the headband. Each of the first earcup and the second earcup may comprise a front plate, an acoustic driver mounted to the earcup, and a tactile vibration driver mounted to the earcup. The acoustic driver has a front side and a back side, and the tactile vibration driver also has a front side and a back side. Each of the first earcup and the second earcup may be configured to be disposed over or on an ear of a user during use of the headphone. The first earcup and the second earcup do not include a rear acoustic cavity adjacent the back side of the acoustic driver, and each of the first earcup and the second earcup may be configured to allow ambient noise outside the earcup to pass through the earcup to the ear of the user without substantial passive isolation of ambient sound or sound generated by the acoustic driver during use of the headphone.

A method of forming an open back headphone may comprise providing an earcup configured to be disposed over or on an ear of a user during use of the headphone, the earcup may include a front plate, mounting an acoustic driver to the earcup, the acoustic driver may have a front side and a back side, mounting a tactile vibration driver to the earcup, the tactile vibration driver may have a front side and a back side, configuring the earcup so as not to include a rear acoustic cavity adjacent the back side of the acoustic driver, and configuring the earcup to allow ambient noise outside the earcup to pass through the earcup to the ear of the user without substantial passive isolation of ambient sound or sound generated by the acoustic driver during use of the headphone.

### BRIEF DESCRIPTION OF THE DRAWINGS

While this disclosure concludes with claims particularly pointing out and distinctly claiming specific embodiments, various features, and advantages of embodiments within the scope of this disclosure may be more readily ascertained from the following description when read in conjunction with the accompanying drawings, in which:

FIG. 1 is a view of an audio system including a side view of an open back headphone;

FIG. 2 is a perspective bottom view of a first earcup of the open back headphone of FIG. 1;

FIG. 3 is a perspective bottom view of a second earcup of the open back headphone of FIG. 1;

FIG. 4 is a cross-sectional side view of the open back headphone of FIG. 1; and

FIG. 5 is a back view of the open back headphone of FIG. 1.

### DETAILED DESCRIPTION

The illustrations presented in this disclosure are not meant to be actual views of any particular open back headphone or component thereof but are merely idealized representations employed to describe illustrative embodiments. Thus, the drawings are not necessarily to scale.

Disclosed are embodiments of open back headphones including tactile vibration drivers configured to provide a tactile vibration sensation and increase the perceived bass quality of the open back headphone, and an earcup which may be open on a back side of the acoustic driver and the back side of the tactile vibration driver to reduce the impact of resonances and low frequency buildup during a listening experience. More specifically, disclosed embodiments to open back headphones may include at least one earcup which may include an acoustic driver and a tactile vibration driver mounted to the earcup. The earcup may not include a rear acoustic cavity adjacent the back side of the acoustic driver and a back side of the tactile vibration driver, and the earcup may be configured to allow ambient noise outside the earcup to pass through the earcup to the ear of the user without substantial passive isolation of ambient sound or sound generated by the acoustic driver during use of the headphone.

Passive isolation is achieved by isolating a user from ambient noise without the use of active noise cancellation technology. For example, if headphones have earcups that partially or completely cover or encompass a user's ear or if earbuds are molded to the exact shape of a user's ears, it reduces perception of outside ambient noise by the user. Typically, passive isolation may be more effective at reducing the intensity of incoming sounds at mid to high frequencies than the intensity of incoming sounds at low frequencies.

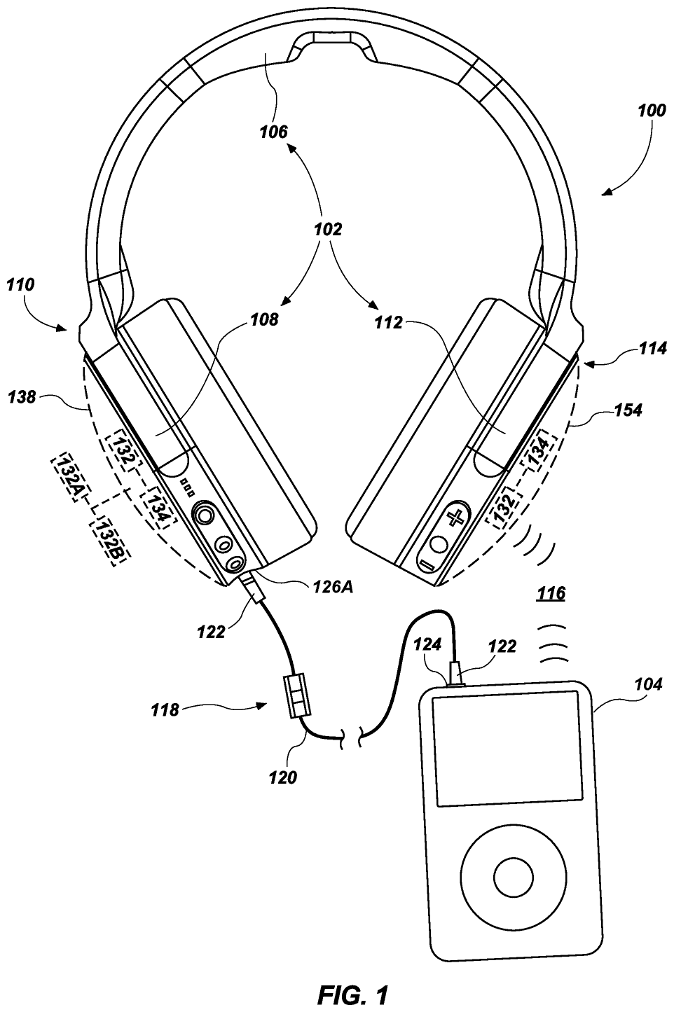

FIG. 1 is a view of an audio system 100 including a side view of an open back headphone 102 configured to receive an audio signal from a media player 104. The open back headphone 102 may include a headband 106, a first earcup 108 suspended from the headband 106 proximate a first end 110 of the headband 106, and a second earcup 112 suspended from the headband 106 proximate a second end 114 of the headband 106. The headband 106 may be sized and shaped to rest on top of the head of a user, and the first earcup 108 and second earcup 112 may be configured to be disposed over or on an ear of a user during use of the open back headphone 102. The first earcup 108 and the second earcup 112 may not exhibit passive isolation. For example, the first earcup 108 and the second earcup 112 may reduce the intensity level of incoming sound by about 15 dB or less.

Each of the first earcup 108 and the second earcup 112 may include an acoustic driver 132 having a front side facing the ear of the user, and an opposite back side. The acoustic driver 132 may be configured to produce audible sound in response to receipt of an audio signal from the media player 104. Each of the first earcup 108 and the second earcup 112 may further include a tactile vibration driver 134 having a front side facing the ear of the user, and an opposite back side. The tactile vibration driver 134 may be configured to produce tactile vibrations in response to receipt of at least a bass component of the audio signal from the media player 104. In other embodiments, each of the first earcup 108 and the second earcup 112 may include another acoustic driver. For example, each earcup 108 and 112 may include a first acoustic driver 132A, which may be configured to emit sound over a wide range of audible frequencies (from treble to bass frequencies, for example) and configured to produce audio playback in response to receipt of an audio signal from the media player 104, and a second acoustic driver 132B, which may be particularly suited for bass playback and configured to produce audio playback in response to receipt of at least the bass component of the audio signal from the media player 104.

The media player 104 may store or have access to at least audio media for playback over the open back headphone 102. The media player 104 may include, for example, a smartphone, tablet, computer, television, e-reader with audio capabilities, digital file player, disc player, radio, stereo, gaming system, etc. The media player 104 may be operatively connected to the open back headphone 102 by a wireless connection 116, over a wired connection 118, or both. For example, the open back headphone 102 may connect wirelessly to the media player 104 utilizing a BLUETOOTH® wireless connection protocol and may form a wired connection to the media player 104 utilizing one or more wires 120 having audio jacks 122 at two, opposite ends thereof. One of the audio jacks 122 may be inserted into a corresponding audio plug 124 of the media player 104, and the one or more of the other audio jacks 122 may be inserted into a corresponding first audio plug 126A located on, for example, the first earcup 108, the second earcup 112, or one on each of the first earcup 108 and the second earcup 112.

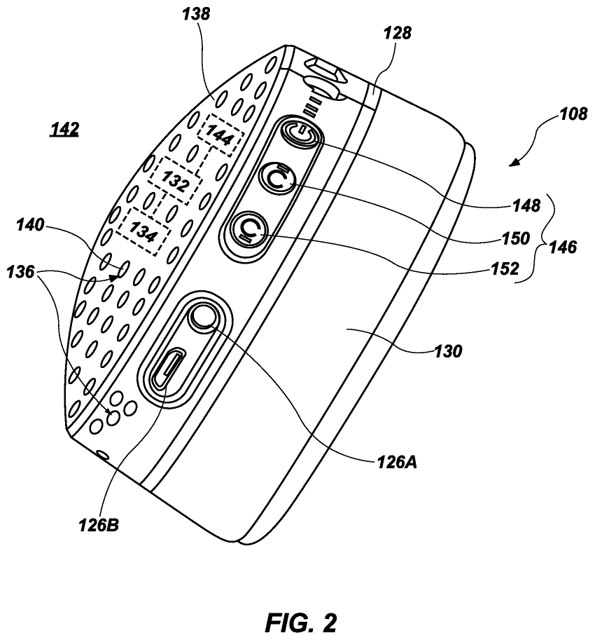

FIG. 2 is a perspective bottom view of the first earcup 108 of the open back headphone 102 of FIG. 1. The first earcup 108 may include a front plate 128 and a cushion 130 located on a side of the front plate 128 proximate the ear of the user when the open back headphone 102 (see FIG. 1) is worn by the user. The tactile vibration driver 134 may be mounted to the front plate 128. The front plate 128 may be adjacent to the front side of the tactile vibration driver 134. The front plate 128 may include apertures 136 extending at least partially through the front plate 128. The front plate 128 may be coupled to a back plate 138. In some embodiments, the front plate 128 may be removably coupled to a back plate 138. The tactile vibration driver 134 may be mounted to the back plate 138. The apertures 136 may be located on the back plate 138 or the apertures 136 may be on the front plate 128 or a combination thereof. The apertures 136 may expose internal components of the first earcup 108 at an exterior 142 of the first earcup 108, such as the acoustic driver 132 and the tactile vibration driver 134. The first earcup 108 may not include an acoustic cavity adjacent to either the front plate 128 or the back plate 138.

In some embodiments, such as that shown in FIG. 2, the first earcup 108 may include a first audio plug 126A configured to accept an audio jack 122 (see FIG. 1) and a second power plug 126B configured to accept a power jack. For example, the first audio plug 126A may be located proximate the bottom of the front plate 128 when the open back headphone 102 (see FIG. 1) is worn by the user between the cushion 130 and the back plate 138, and may be configured as, for example, a tip-ring-sleeve-type plug. More specifically, the first audio plug 126A may be configured in a tip-ring-sleeve (TRS), tip-ring-ring-sleeve (TRRS), tip-ring-ring-ring-sleeve (TRRRS), etc., and may operably couple with audio jacks 122 (see FIG. 1) having complementary configurations. The second power plug 126B may be located adjacent to the first audio plug 126A at the bottom of the front plate 128 when the open back headphone 102 (see FIG. 1) is worn by the user, and the second power plug 126B may be configured as, for example, a power-and-data-connection-type plug specifically configured to receive power to charge a battery 144 configured to power electrical components of the open back headphone 102 (see FIG. 1). More specifically, the second power plug 126B may be configured as, for example, a universal serial bus (USB), mini-USB, or LIGHTNING® connector. Although specific examples have been provided, the first audio plug 126A or audio and power plugs 126A and 126B may be configured as any type of plug for receiving an audio jack 122 (see FIG. 1) configured to convey audio signals, power, or both. In other embodiments, the second power plug 126B may further be configured to receive an audio signal via a data connection portion of the power-and-data-connection-type plug.

The first earcup 108 may further include buttons 146 configured to selectively affect the powered state or the operation of the open back headphone 102 (see FIG. 1), the buttons 146 located on the front plate 128 between the cushion 130 and the back plate 138. For example, the first earcup 108 may include a power button 148 configured to power and un-power powered electrical components of the open back headphone 102 (see FIG. 1) in response to successive and/or sustained presses. In addition, the first earcup 108 may include a vibration increase button 150 and a vibration decrease button 152 configured to affect the tactile vibration driver(s) 134. The vibration increase button 150 and the vibration decrease button may increase and decrease the intensity of vibrations produced by the tactile vibration driver(s) 134 in response to pressing the vibration increase button 150 or vibration decrease button 152.

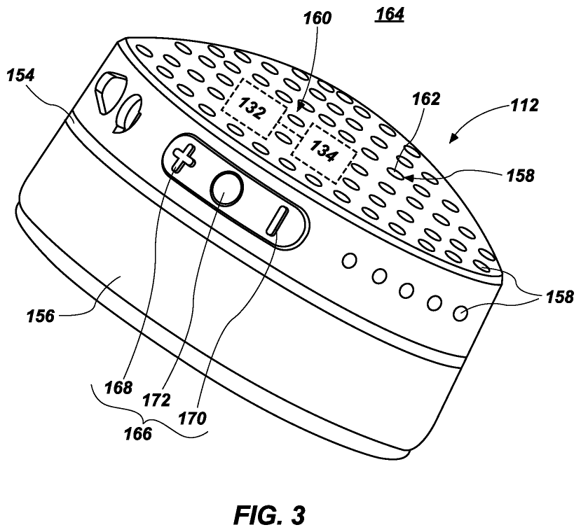

FIG. 3 is a perspective bottom view of the second earcup 112 of the open back headphone 102 of FIG. 1. Like the first earcup 108 (see FIG. 2), the second earcup 112 may include a front plate 154 and a cushion 156 located on a side of the front plate 154 proximate the ear of the user when the open back headphone 102 (see FIG. 1) is worn by the user. The tactile vibration driver 134 may be mounted to the front plate 154. The front plate 154 may include apertures 158. The front plate 154 may be coupled to a back plate 160 located on a side of the front plate 154 opposite the cushion 156. The tactile vibration driver 134 may be mounted to the back plate 160. The apertures 158 may be located on the back plate 160 or the apertures 158 may be on the front plate 154 or a combination thereof. The apertures 158 may extend at least partially through the back plate 160 of the front plate 154. The apertures 158 may expose internal components of the second earcup 112 at an exterior 164 of the second earcup 112 such as the acoustic driver 132 and the tactile vibration driver 134. The open back headphone 102 may include a microphone 140 (see FIG. 2) and 162 on each of the earcups 108 (see FIG. 2) and 112. In other embodiments, only one of the earcups 108 (see FIG. 2) and 112 may include the microphone 140 (see FIG. 2) or 162.

The second earcup 112 may include a multifunction button 166 configured to increase and decrease a volume of the acoustic drivers 132, the tactile vibration drivers 134, and otherwise affect operation of the open back headphone 102 (see FIG. 1), the multifunction button 166 located on the front plate 154 between the cushion 156 and the back plate 160. For example, the multifunction button 166 may include a volume increase button 168, a volume decrease button 170, and a central button 172 that may, for example, increase volume of the acoustic drivers 132, decrease volume of the acoustic drivers 132, start and stop playback, accept voice calls, initiate voice commands, and otherwise affect operation of the open back headphone 102 and associated media player 104 (see FIG. 1) depending on press occurrence, number, and/or duration.

While specific combinations of features for individual earcups 108 and 112 have been shown and described in connection with FIGS. 1 through 3, those features may be placed in different combinations with one another on either earcup 108 or 112. For example, the first audio plug 126A and second power plug 126B may be located on the earcup 108 or 112, the first audio plug 126A may be located on a different earcup 108 or 112 than the second power plug 126B, the buttons 146 and 166 may be located on the same earcup 108 or 112, etc. In some embodiments, the first audio plug 126A and second power plug 126B and the buttons 146 and 166 may be located on the back plate 138 of the first earcup 108, the back plate 160 of the second earcup 112, in the apertures 136 or 158, or any combination of locations previously described. The apertures 136 and 158 may be cylindrical, square, triangular, oval, rectangular, etc., or any combination thereof.

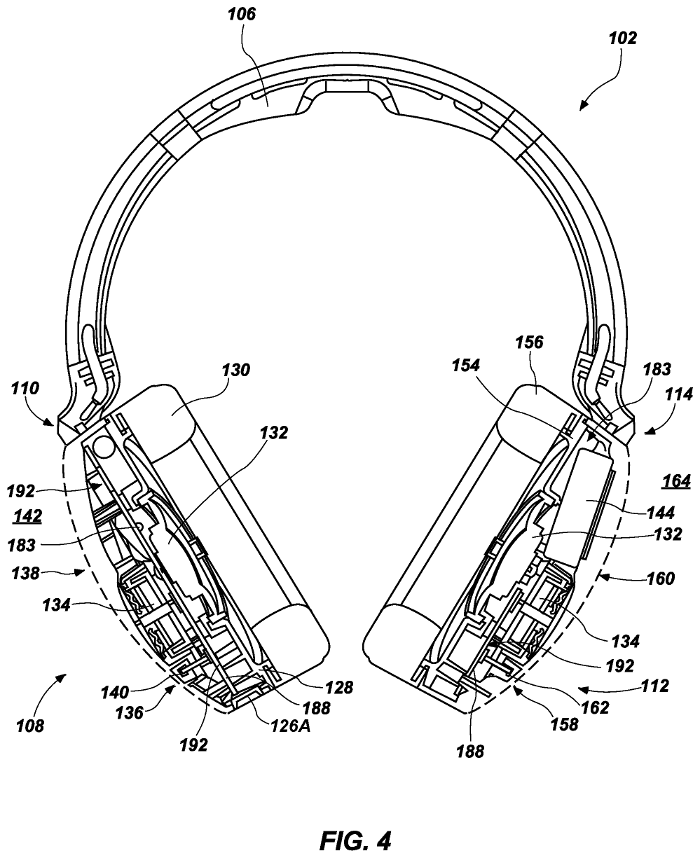

FIG. 4 is a cross-sectional side view of the open back headphone 102 of FIG. 1. The front plate 128 and 154 of each earcup 108 and 112 may partially define an interior region 183 within each earcup 108 and 112. The acoustic driver 132 and the tactile vibration driver 134 may be disposed within the interior region 183. The interior region 183 may be configured to be in direct or indirect communication with an outside environment such that air and/or sound may be able to pass in and out of the interior region 183 while the open back headphone 102 is in use. In each of the earcups 108 and 112, the respective back plates 138 and 160 may be located opposite the front plates 128 and 154 and at least partially define the interior region 183. The apertures 136 in the back plate 138 may be configured to cover only a portion of the back plate 138. In some embodiments, the apertures 136 may have a combined cross-sectional area equal to at least twenty-five percent, at least thirty-three percent, at least fifty percent, at least sixty-six percent, at least seventy-five percent, or substantially one hundred percent of an area encompassed by a peripheral edge of the back plate 138. In some embodiments, the back plate 138 may be formed as one continuous part of the front plate 128. In some embodiments, the back plate 138 may be absent, resulting in a substantially unobstructed open back on the first earcup 108. In some embodiments, the back of the first earcup 108 may be completely open. The apertures 158 in the back plate 160 may be configured to cover only a portion of the back plate 160. In some embodiments, the apertures 158 may have a combined cross-sectional area equal to at least twenty-five percent, at least thirty-three percent, at least fifty percent, at least sixty-six percent, at least seventy-five percent, or substantially one hundred percent of an area encompassed by a peripheral edge of the back plate 160. In some embodiments, the back plate 160 may be formed as one continuous part of the front plate 154. In some embodiments, the back plate 160 may be absent, resulting in a substantially unobstructed open back on the second earcup 112. In some embodiments, the back of the second earcup 112 may be completely open. A driver plate 188 may subdivide the interior region 183. The driver plate 188 may be located between the acoustic driver 132 and the tactile vibration driver 134. The driver plate 188 may include at least one passage 192 to allow air and/or sound to travel through the driver plate. The at least one passage 192 may facilitate the release of pressure and sound buildup within the interior region 183 during operation of the open back headphone 102.

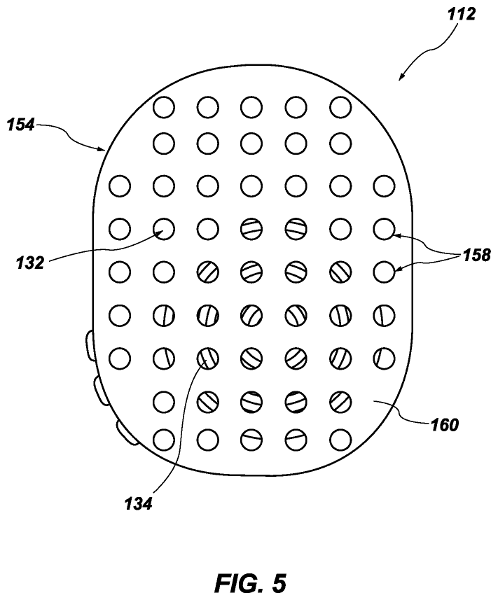

FIG. 5 shows a back view of the second earcup 112. The second earcup 112 may include apertures 158. The apertures 158 may be located on the back plate 160. In some embodiments, the front plate 154 may include apertures 158. The apertures 158 may expose internal components such as the acoustic driver 132 and the tactile vibration driver 134. The apertures 158 may be evenly spaced on the second earcup 112. Evenly spaced apertures 158 may facilitate even release of at least a portion of audible noise outside of the intended audible response of the acoustic driver 132 and/or the tactile vibration driver 134 to be transferred from the interior of the front plate 154 to the exterior of the front plate 154. The apertures 136 may be configured to facilitate the same effects for the first earcup 108 as described above with respect to the apertures 158 for the second earcup 112.

A method of forming the open back headphone 102 may comprise providing the first earcup 108 and/or the second earcup 112, each earcup 108 and 112 configured to be disposed over or on an ear of a user during use of the open back headphone 102. The earcup 108 and 112 include a respective front plate 128 and 154. The method may include mounting the acoustic driver 132 to the earcup 108 and 112, the acoustic driver 132 having a front side and a back side and mounting the tactile vibration driver 134 to the earcup 108 and 112, the tactile vibration driver 134 having a front side and a back side. The method may include configuring the earcup 108 and 112 so as not to include a rear acoustic cavity adjacent the back side of the acoustic driver 132 and the back side of the tactile vibration driver 134 and configuring the earcup 108 and 112 to allow ambient noise outside the earcup 108 and 112 to pass through the earcup 108 and 112 to the ear of the user without substantial passive isolation of ambient sound or sound generated by the acoustic driver 132 during use of the headphone. The method may further comprise mounting a back plate 138 and 160 to the respective earcup 108 and 112.

While certain illustrative embodiments have been described in connection with the figures, those of ordinary skill in the art will recognize and appreciate that the scope of this disclosure is not limited to those embodiments explicitly shown and described in this disclosure. Rather, many additions, deletions, and modifications to the embodiments described in this disclosure may be made to produce embodiments within the scope of this disclosure, such as those specifically claimed, including legal equivalents. In addition, features from one disclosed embodiment may be combined with features of another disclosed embodiment while still being within the scope of this disclosure, as contemplated by the inventors.

1. An open back headphone, comprising:
an earcup configured to be disposed over or on an ear of a user during use of the headphone, the earcup including a front plate;
an acoustic driver mounted to the earcup, the acoustic driver having a front side and a back side; and
a tactile vibration driver mounted to the earcup, the tactile vibration driver having a front side and a back side; and
wherein the earcup does not include a rear acoustic cavity adjacent the back side of the acoustic, and the earcup is configured to allow ambient noise outside the earcup to pass through the earcup to the ear of the user without substantial passive isolation of sound generated by the acoustic driver during use of the headphone.

2. The open back headphone of claim 1, wherein the earcup further comprises a back plate coupled to the front plate, the front plate and the back plate defining an interior region within the earcup, the acoustic driver and the tactile vibration driver disposed within the interior region of the earcup.

3. The open back headphone of claim 2, wherein the back plate is removably coupled to the front plate.

4. The open back headphone of claim 2, wherein the back plate includes a plurality of apertures extending through the back plate.

5. The open back headphone of claim 4, wherein the apertures of the plurality have a combined cross-sectional area equal to at least twenty-five percent of an area encompassed by a peripheral edge of the back plate.

6. The open back headphone of claim 2, wherein the tactile vibration driver is mounted to the back plate.

7. The open back headphone of claim 4, wherein the apertures are cylindrical in shape.

8. The open back headphone of claim 1, wherein the front plate of the earcup includes at least one aperture extending through the front plate.

9. The open back headphone of claim 8, wherein the front plate of the earcup includes a plurality of apertures extending through the front plate.

10. An open back headphone, comprising:
a headband;
a first earcup located at a first end of the headband;
a second earcup located at a second end of the headband; and
wherein each of the first earcup and the second earcup comprises:
a front plate;
an acoustic driver mounted to the earcup, the acoustic driver having a front side and a back side; and
a tactile vibration driver mounted to the earcup, the tactile vibration driver having a front side and a back side; and
wherein each of the first earcup and the second earcup is configured to be disposed over or on an ear of a user during use of the headphone, each of the first earcup and the second earcup does not include a rear acoustic cavity adjacent the back side of the acoustic driver, and each of the first earcup and the second earcup is configured to allow ambient noise outside the earcup to pass through the earcup to the ear of the user without substantial passive isolation of sound generated by the acoustic driver during use of the headphone.

11. The open back headphone of claim 10, wherein the tactile vibration driver is configured to vibrate at frequencies below 250 Hz.

12. The open back headphone of claim 10, wherein each of the first earcup and the second earcup further comprises a back plate coupled to the front plate, the front plate and the back plate defining an interior region within the earcup, the acoustic driver and the tactile vibration driver disposed within the interior region of the earcup.

13. The open back headphone of claim 12, wherein the back plate is removably coupled to the front plate.

14. The open back headphone of claim 12, wherein the back plate includes a plurality of apertures extending through the back plate.

15. The open back headphone of claim 14, wherein the apertures of the plurality have a combined cross-sectional area equal to at least twenty-five percent of an area encompassed by a peripheral edge of the back plate.

16. The open back headphone of claim 12, wherein the tactile vibration driver is mounted to the back plate.

17. The open back headphone of claim 14, wherein the apertures are cylindrical in shape.

18. A method of forming an open back headphone, the method comprising:
providing an earcup configured to be disposed over or on an ear of a user during use of the headphone, the earcup including a front plate;
mounting an acoustic driver to the earcup, the acoustic driver having a front side and a back side;
mounting a tactile vibration driver to the earcup, the tactile vibration driver having a front side and a back side;
configuring the earcup so as not to include a rear acoustic cavity adjacent the back side of the acoustic driver; and
configuring the earcup to allow ambient noise outside the earcup to pass through the earcup to the ear of the user without substantial passive isolation of sound generated by the acoustic driver during use of the headphone.

19. The method of claim 18, further comprising mounting a back plate to the earcup.

20. The method of claim 18, wherein providing the earcup comprises providing a first earcup and a second earcup.
